(19) United States
(12) Patent Application Publication
(10) Pub. No.: US 2023/0294959 A1
(43) Pub. Date: Sep. 21, 2023

(54) ELEVATOR INTERACTION IN PUBLIC SPACES

(71) Applicant: KONE Corporation, Helsinki (FI)

(72) Inventor: Juan PAMANES, McKinney, TX (US)

(73) Assignee: KONE Corporation, Helsinki (FI)

(21) Appl. No.: 18/202,607

(22) Filed: May 26, 2023

Related U.S. Application Data
(63) Continuation of application No. PCT/US2020/064216, filed on Dec. 10, 2020.

(51) Int. Cl. B66B 1/46; B66B 1/34

(52) U.S. Cl. CPC B66B 1/468; B66B 1/3461; B66B 2201/232; B66B 2201/4676; B66B 2201/4653; B66B 2201/4638; B66B 2201/4615; B66B 2201/103

(57) ABSTRACT

In methods and a system for enabling temporary interaction between a user device of a passenger and an elevator or an elevator group provided for public use in a public space, a database is maintained that includes information on at least one elevator or elevator group available for public use. A user device sends a request message that includes validation information. The request message is validated by verifying that the unique identification of the elevator or elevator group in said validation information is among said at least one elevator or elevator group available for public and that geographical locations of the user device and the elevator or elevator group fulfill a predefined proximity criterion. If the request message is deemed valid, temporary access is granted to an elevator application running on the user device for entering at least one call for elevator service via an elevator call API.

### FIELD

The present invention relates to methods, a system and computer program products related to passenger interaction with elevators. More particularly, the invention relates to methods, a system and computer program products that grant temporary access for passengers to interact with an elevator or elevator group in public spaces in touchless manner.

### BACKGROUND

Recent pandemics have arisen awareness and requirements of public health and hygiene to new levels. While indoors in general are considered to increase risk for spreading contagious diseases, studies have shown that surfaces touched by many people may provide a platform for spreading infection. One commonly referred risky surface is call and operation panels of elevators.

Modern elevators are controlled by computing systems. For example, a destination control system is a system that receives calls from calling devices, processes received calls and allocates elevators to passengers who have placed the calls. Such systems, however, typically include functionality that have issues with regard the elevator and the building safety. For example, the elevator control system may be attached to an access control system. The access control system is controlling access rights in a building, for example, to which floors a person may place a call and which doors he is authorized to open. In other words, elevators include a plurality of different features that require verifying if the person giving the instructions has rights to do so.

FIG. 1 illustrates a system for enabling interaction between an elevator call application and elevator or elevator group as known in the art.

Application programming interface (API) modules (115) provide connectivity for the respective elevator (120) or elevator group (130) comprising more than one elevator (120) and exposes the elevator call interface from physical call panel(s) to the Internet. This functionality enables operations like remote elevator call even for conventional elevators. The API module (115) is implemented as a gateway device positioned between the elevator or elevator group and API's provided by a digital service platform (110), which may be implemented as a cloud service. The API module (115) may provide cellular connectivity, for example 3G, 4G or 5G network connectivity to the elevator or elevator group for transferring data to and from the digital service platform (110).

Various site devices (125) communicate with the digital service platform (110). A site communication API (104) may be provided by the digital service platform (110) for this communication. Alternatively, a web service provided by the digital service platform (110) may be accessed by the site device (125) over internet, for example using a web browser. A site device (125) may be used for example to add and/or remove users and/or to modify existing users' access rights.

Elevator call APIs (105) are part of the digital service platform (110). An elevator call APIs (105) may be provided by the digital service platform (110) as an API management service. Elevator call APIs (105) provide a predefined interface that may be used to exchange predefined types of information between parties.

The elevator call API (105) provides a standardized interface between the digital service platform (110) and elevator call applications implemented for example in user devices (100). For example, current KONE elevator call API provides following types of data and features over the API:

### Elevator Call Features:

Landing call: a call that has only departure area and direction information
Destination call: a call that has both departure and destination area information

### Static Data:

Building information: building ID, area, number of floors served
KONE elevator group information: elevator type, name, location

### Dynamic Data:

Elevator location status: current floor, next stop, elevator direction
Call single status: call created, approved, served, cancelled
Call insights: location of assigned elevator, reason for call cancelation, estimated time to arrival
Passenger guidance: wait for car, enter car, stay inside car, exit car

Calls made over the elevator call API preferably comprise a user identification, which enables managing access rights of registered users as will be described.

Mobile devices (100) may be equipped with an elevator call application that utilizes the elevator call API (105) to communicate user's elevator calls to an elevator or elevator group over the digital service platform (110). However, the elevator call application does not automatically have access to every elevator or elevator group, but in order to grant access to a specific elevator or elevator group, user needs to be registered to a site user database that is maintained by a site manager associated to the respective site. Only users registered in the site user database have access to the elevators or the group of elevators in the facility. Further, site user database may restrict user's access to a subset of elevators and/or a subset of floors at the site. User registration and identification may be based on establishing an account for the user in the digital service platform (110) by defining a username and a password, which are used for accessing the elevator call application. The site manager, using his/her site device (125), grants access for the user to some or all Building IDs and/or elevator group IDs and/or elevator IDs within the site by storing the respective username in the site user database and associating it with respective ID (unique identifier). Each time a user makes a request for an elevator call using the elevator call application, identity of the user is sent to the digital service platform (110) together with identity of the elevator or elevator group the request concerns. The user identity is compared to user identities stored in the site user database, and if there is a match, the elevator call is validated. Registration that allows access to the elevators may be further associated with other access management systems, such as access control systems managing authorization to open electronic locks to access predefined buildings, facilities and/or spaces on the site. This kind of registration solution works well for residential and office spaces, where same users regularly access the same premises. It may also be possible to limit user's access to the elevator system to specific allowed floors only, while disabling access to restricted floors.

This kind of API based system enables implementing elevator call applications in the user devices (100), which enable the user to enter calls using the user interface of his/her user device rather than using the call panels provided at the site and in the elevator car, which may be touched by many people and which may thus facilitate spreading of infections. The digital service platform with an open elevator call API is not restricted to a single elevator call application provider.

However, above described registration requirement for users of the elevator for each site is not practical in public spaces, where users may visit occasionally or just once, and where number of visitors may be huge.

### DESCRIPTION OF THE RELATED ART

Patent application US2019/0100405 A1 discloses a method for authorizing elevator requests to specific floors. A registered user sends request from a mobile application for traveling between defined floors of a building with an elevator, and a server makes decision on whether the user is authorized or not.

Patent application US 2017/0243417 A1 discloses providing a one-time token to a user for making elevator call requests. A property manager requests provision of the one-time token for the user.

Patent application WO2017/051059 A1 discloses an application programming interface manager in a mobile device that provides an API for elevator related applications. The API has a certificate that is used for identifying the person using the mobile device.

### SUMMARY

An object is to provide a method and apparatus so as to solve the problem of enabling touch-free elevator calls in elevators in public spaces without requiring registration of the user. The objects of the present invention are achieved with methods according to claims 1 and 9, and with computer program products according to claims 16 and 17. The objects of the present invention are further achieved with a system according to the claim 18.

The preferred embodiments of the invention are disclosed in the dependent claims.

The present invention is based on the idea of enabling a user interface provided by an elevator call application running in the passenger's own mobile user device to be used for making elevator calls in public spaces without requirement to register the user in advance for authorizing use of the user's elevator call application with elevators available for public. This is achieved by granting a temporary access to the elevator call application running on the user device for communicating with the elevator identified in a request message. This communication for entering an elevator call occurs via the elevator call application programming interface (API) provided for the elevator call application, when the elevator is registered as being available for use by public and when current location of the user device has been validated by a two-factor validation that disables malicious use of the elevator call application. For validating the user device's and thus also the user's current location, both location information of the user device and on-site interaction by the user device with a touchless token are used to provide the two-factor validation of the user device's current location.

### BRIEF DESCRIPTION OF THE DRAWINGS

In the following the invention will be described in greater detail, in connection with preferred embodiments, with reference to the attached drawings, in which

FIG. 1 illustrates a system for enabling interaction between an elevator application and elevator or elevator group as known in the art.

FIG. 2 illustrates a system that enables granting temporary interaction between a user device of a passenger and an elevator or an elevator group provided for public use in a public space.

FIGS. 3a and 3b illustrate examples of displaying information on elevators or elevator groups available for public in a user interface of the user device.

FIGS. 4a and 4b illustrate an exemplary user interface of an elevator application.

### DETAILED DESCRIPTION

The term public spaces refer to buildings which are available for access by public. For example, public spaces may be retail spaces such as malls, department stores or shopping centers, infrastructure facilities, such as airports, train stations or metro stations, healthcare facilities such as hospitals and so on.

The term elevator call application refers to a user application provided in a mobile device of a user that enables communication of the user's elevator calls to an elevator or an elevator group.

The term public elevator refers to an elevator or an elevator group that has been registered in a database as being available for public use in a public place.

As used herein, terms computer or computer system refer to physical or virtual computational entities capable of enhancing information and to perform computational tasks. The term computer system refers to one entity or a group on entities configured to operate jointly with capabilities for running an application.

As used herein, the term application refers to a proprietary software enabling a computer or computer system to perform a particular computer-implemented task or tasks. The application software contains such instructions that, when executed by one or more processors, causes a computing device to perform tasks. The application may also be referred as software application, application program, application software, app, for example. It is to be noted that in at least some of the example embodiments also system software providing a platform for running the application can be considered functionally similar, or as part of to the application. Alternatively, or in addition to, also set of instructions based on a mark-up language may be considered as an application. The application may be used on a computing device, in several computing devices, on a server or several servers and it may utilize cloud computing.

As used herein, a “computer-readable medium” can be any means that can contain, store communicate, propagate or transport the program for use by or in connection with the instruction execution system, apparatus or device. The computer readable medium can be, for example, but not limited to, an electronic, magnetic, optical, electromagnetic, infrared or semiconductor system, apparatus, device or propagation medium. A non-exhaustive list of more specific examples of the computer-readable medium can include the following: an electrical connection having one or more wires, a portable computer diskette or memory device, a random access memory (RAM), a read-only memory (ROM), an erasable programmable read-only memory (EPROM or Flash memory), an optical fibre, and a portable compact disc read-only memory (CDROM).

In the following, geographical location of an elevator or elevator group refers to a geographical location directly or indirectly associated with the elevator or elevator group. Direct association may be between a unique identifier of the elevator and its geographical location or between a unique identifier of an elevator group and its geographical location. Indirect association of the geographical location may be for example obtained when a geographical location of a building or a site is associated to one or more elevator or elevator groups in that building or on that site, in which case the geographical location registered and used in the system and method may be the same for more than one elevator or elevator group.

In the following, the term elevator may be used for simplicity to refer to an elevator or an elevator group. An elevator group is a group of elevators that serve same building in the same site, and which are controlled as a group so that any one elevator in the elevator group may be allocated to serve a passenger who makes an elevator call to the elevator group.

FIG. 2 illustrates a system and method that enables granting temporary interaction between a user device (100) of a user (200) and an elevator (120) or an elevator group (130) provided for public use in a public space. The user (200) may also be referred to as a passenger.

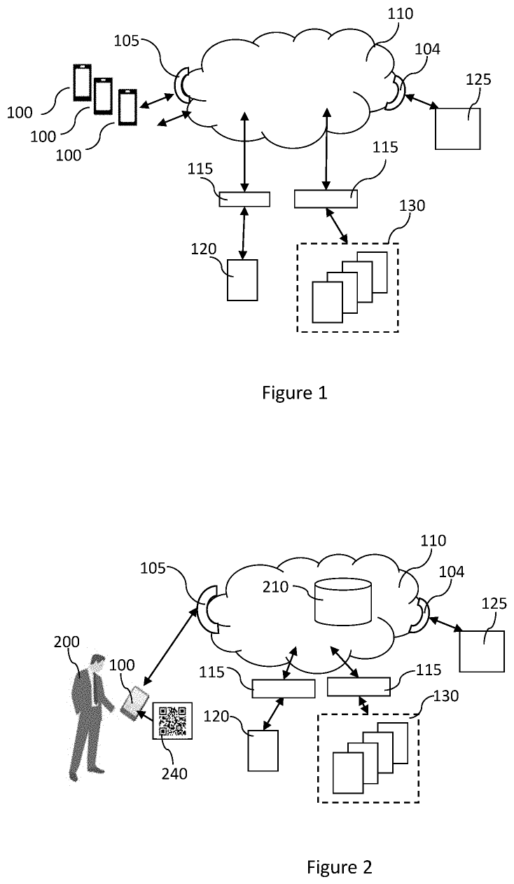

This system is based on the system illustrated above in connection to the FIG. 1, and basic elements and their basic functionalities are as explained in connection to the FIG. 1. For enabling utilization of the elevator call application for making elevator calls for elevators available for public use, the system further comprises a database (210) for collecting and storing information on elevators and elevator groups. Site devices (125) may communicate with the digital service platform (110) for registering certain elevators or elevator groups as public elevators. This information is stored in the database (210). Preferably, the database comprises general information on each elevator, such as a site identifier and/or street address, a unique identifier of the elevator (120) or the elevator group (130), and information on geographical location associated with the respective elevator. Geographical location is preferably indicated with geographical coordinates using any predefined coordinate system known in the art. Geographical location associated with the elevator or the elevator group may be stored for each elevator or elevator group, for each building on a site or for each site. The database (210) may include information on both publicly available elevators and not publicly available ones, or information on publicly available elevators and elevator groups only. Further, the database may comprise additional information related to elevators, such as numbers of floors served by each elevator, identification of public floors served by each elevator and so on.

By registering some or all of their elevators as being public elevators, in other words being available for public, the site manager makes at least its elevators or its site part of the database (210), which is accessible by any end user that has an elevator call application installed in their user device that uses the standardized cloud API (105).

The elevator application in the user device (100) obtains location information of the user device for determining location of the user. The location information may be for example information provided by a global navigation system such as GPS, GNSS or Glonass, and/or an indoor navigation system available in the user device, such as a mobile phone or other type of handheld computing device with communication capabilities. The location of the user device may be a geographical location of the user device. Location of the user device is preferably obtained from a location information system that can be trusted, i.e. a location information that cannot be spoofed for example by the user. In such case, the location information may be referred to as a trusted location information. The elevator application in the user device may send the location information of the user device to the digital service platform (110), which compares the geographical location of the user device to geographical locations of public elevators stored in the database (210). A predefined proximity criterion is used by the digital service platform (110) for defining, which public elevators stored in the database (210) are selected to be suggested to the user as available public elevators. The predefined proximity criterion preferably comprises a proximity radius defining a maximum allowed distance between the location of the user device and the geographical location of the public elevator. Alternatively, or in addition, the proximity criteria may comprise a threshold value defined as a time, which sets an upper limit to an estimated time of arrival of a user at the elevator by walking. Information on the available public elevators fulfilling the proximity criterion is returned to the application, which provides information on available public elevators nearby available for touchless use by the user.

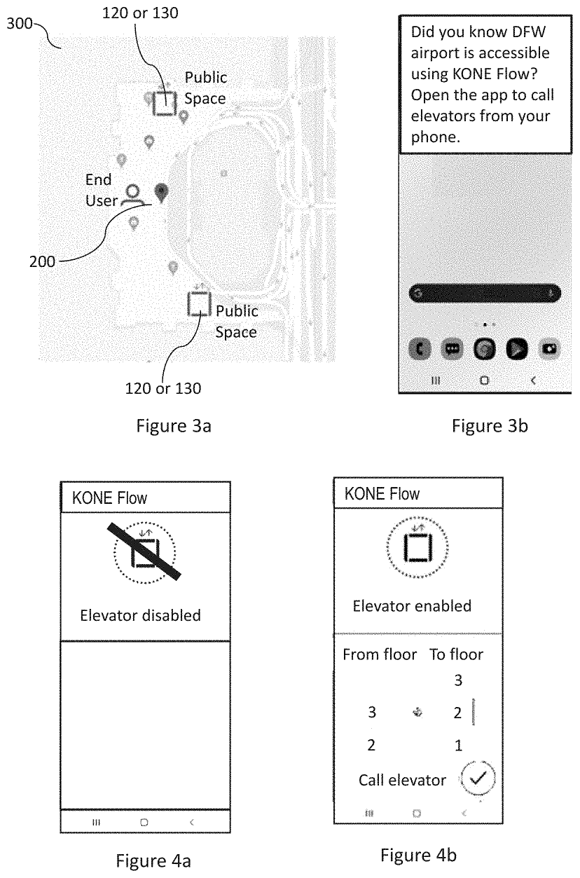

FIGS. 3a and 3b show two examples of how suggestions of available public elevators near the user can be shown to the user in the user device (100). In the FIG. 3a, the user interface displays a map that shows one or more public elevator icons placed on the map, possibly with names and/or other indication of public availability, wherein the icons indicate at least approximate locations of public elevators. Such map-based presentation assumes that geographical location of the elevators is available to the user device application so that the respective icons may be placed correctly on the underlying map. Thus, for enabling this kind of view, the digital service platform (110), upon selecting one or more public elevators fulfilling a proximity criterion to be proposed for the user application in response to the polling, provides in the response to the polling the geographical location information of the selected public elevators to the user device, and so that the user device can display the respective at least one location on a map. Any format of geographical location information known in the art may be used. In the FIG. 3b, an example of text formatted indication of available public elevator in the user interface of the user device (100) is shown. Instead of a single publicly available elevator service, a list of few nearest available public elevators fulfilling the predefined proximity criterion may be provided in the user interface. Selection of the one or more elevators to be displayed by the user device is based on a comparison between the current location of the user device and geographic locations of elevators registered in the database (210). Information on available public elevators is preferably dynamically updated when the user moves and previously displayed public elevators are not shown any more when the predefined proximity criterion is not fulfilled any more. Dynamical updating is preferably performed by performing periodical queries, also referred to as polling, of available public elevators by the elevator call application, which may run in the user device on background.

If the user is at one of the suggested sites, she/he may validate his current location nearby the elevator or elevator group and indicate his/her wish to use the elevator application to access the elevators located at the site. For validation purposes, the user uses his/her user device to interact with a touchless token (240) located nearby the respective elevator or elevator group. The touchless token may be of any type that can be used for transmitting or providing data towards the user device (100) in touchless manner. For example, the touchless token may be a two-dimensional code such as a quick response (QR) code, that can be read with a camera of the mobile device. The touchless token may be a near field communication (NFC) tag, a Bluetooth Low Energy (BLE) beacon or any other short-range radio communication token known in the art. The touchless token may even utilize ultrasonic data-over-sound technology that utilizes high-frequency sounds to transmit data that can be received using a microphone of the user device. The invention is as such agnostic to which type of touchless token technology is utilized.

The elevator call application interacts with the touchless token, and thereby receives validation information, which comprises a unique identification of the elevator or the elevator group. The validation information may further comprise information on a current floor. The elevator call application obtains the validation information carried by the touchless token either by reading it or receiving it wirelessly using any available communication technology. Validation information, or at least part thereof is preferably provided in an encrypted format to protect the data and to prevent intercepting and/or misusing the validation information. The current floor may also be provided in non-encrypted form so that it may be utilized by the elevator call application to determine the current floor automatically.

The validation information is forwarded by the elevator call application to a validation service hosted in the digital service platform (110). Preferably, the validation information is comprised in a request message sent to the validation service in the same format as it was obtained from the touchless token. The request message preferably comprises also a unique user identification of the user.

If the validation information is in encrypted format, it is first decrypted by the validation service provided by the digital service platform (110).

If the user is a registered user of the elevator call application, the user identification sent in the request message identifies the user in the digital service platform. The user identification may in such case be registered by a site manager as a user of public elevators. In such case, authorization of the user may be based on validating the request on basis of the encrypted validation data and comparison of the user identity with the site user database. However, such registration of users to each site with public elevators is not necessary.

Validation of the request message may be performed to any user based on the location of the user device and the validation data provided in the request message, without a need for a site user database in which the user needs to be registered by the site manager for granting access.

The method may also be performed without prior queries by the user device on elevators available for public nearby. In such case, the digital service platform (110) has no prior knowledge of the location of the user device (100), but the elevator call application should include location of the use device in the request message.

Only request messages for placing elevator calls for public elevators that have been identified as fulfilling the proximity criterion may be validated. The digital service platform (110) may keep track on which public elevators fulfill the proximity criterion with respect to the current location of the user device as received in most recent periodical query from the user device, and/or current location of the user device may be included in the request message. The digital service platform (110) may then check whether the unique elevator identification included in the encrypted validation data in the request message corresponds to unique identification of one of the public elevators that were identified as fulfilling the predefined proximity criterion. If there is a match between the unique elevator identifications, the request is deemed valid.

When the validation information is deemed valid, the validation service grants the user temporary access to the elevator identified in the validation data included in the request message and returns an acknowledgement message to the user device. If the user is a registered user, user identity received in the now validated request message is associated in the digital service platform with a temporary access to this particular elevator. The temporary access may be restricted to a single elevator call and/or which may be valid for a limited period of time.

Upon receiving an acknowledgement indicating temporary access authorization, the user application preferably indicates to the user that he/she can now place an elevator call using his/her elevator call application. FIGS. 4a and 4b illustrate exemplary views of the user interface of the elevator call application. In the FIG. 4a, the request has not been validated, and the elevator is disabled. FIG. 4b shows an exemplary user interface of the elevator call application after the acknowledgement message indicating grant of the temporary access authorization to the user has been received. Status information indicates that the elevator is now enabled, and a destination floor selection may be provided for the user. “From floor”, corresponding to the current floor of the user, may be automatically preset in the user interface based on the current floor information included in the validation information obtained from the touchless token. If the validation information obtained by the user device from the touchless token was encrypted, it cannot be interpreted directly by the elevator call application. The current floor information may however be provided to the elevator call application in the acknowledgment message in a format comprehensible by the elevator call application. This is particularly useful, if the temporary access is granted for placing a single elevator call, but it may also be used when placing first elevator call during a preset time period.

When the temporary access is granted, and the user requesting temporary access is a registered user in the digital service platform, the digital service platform temporarily stores the user identity into a temporary user database in which the identity is associated with the specific public elevator. Upon receiving the elevator call placed using the elevator call application, the digital service platform confirms the user identity of the incoming elevator call by comparing it with the user identity stored in the temporary user database, registers the incoming elevator call and sends the request to the specified elevator. The digital service platform then waits until the specified elevator sends a confirmation from the elevator group that the elevator call is served. If the temporary access is for single call, the user identifier is removed from the temporary user database upon receiving the confirmation that the call has been served. If the temporary access is for a predefined period of time, the user identity is removed from the temporary user database for the respective site upon expiry of the predefined time period to make one or more elevator calls irrespective of whether a call was made during the predefined time period or not. After removal of the user identity from the temporary user database, the user application needs to make a new request for temporary access if further calls are to be made.

Temporary access may also be granted to users who are not registered in the digital service platform. This may occur for example when the elevator call application in the user device is a third-party application, which is authorized to utilize the elevator call API. In such case, the user may have no user identity in the digital service platform, or the user may have a user identity, but this is not registered in the digital service platform. In such case, a validation message is sent by the user is validated like that of a registered user. Since there is no existing known user identity for this user in the digital service platform, an alternative solution is needed for enabling granting and registering the temporary access. For this purpose, a temporary user token may be generated and shared with the elevator call application in the acknowledgement message. The temporary user token is also stored in the temporary user database. The temporary user token may be for example a random number or character string. The elevator call application includes this temporary user token in the elevator call that is subsequently sent to the digital service platform. The temporary user token is handled in the same manner as a unique identifier of a registered user; upon expiry of the temporary access based either on placing the one elevator call and/or upon expiry of the predefined time period to make one or more elevator calls, the temporary access token is removed from the temporary user database for the respective site, after which the user application needs to make a new request for temporary access if further calls are to be made. In some embodiments, also users who have an existing user identity registered in the digital service platform may be provided with a temporary user token when they request access to an elevator available for public. This ensures that there is no identifiable record of any user stored in the temporary user database.

Alternatively, or in addition to temporary access for a single elevator call, temporary access may be set to be valid for a predefined period of time. There may be a time limit for a single call access so that it expires after the predefined time period has lapsed irrespective of whether the single call was made or not. If the temporary access is granted for a predefined time period, for example for a quarter of an hour, an hour or for a few hours, the digital service platform may enable the user to make multiple elevator calls during the predefined period, but removes the user identity or the temporary user token form the temporary user database upon expiration of the predefined time period. In each case, the user may request for another temporary access to the public elevator by obtaining validation information from the same touchless token or from a different touchless token, for example in a different floor or for a different public elevator.

For further increasing security and disabling misuse of the system for example by making malicious elevator calls, the application software may implement at least one further location-based or time-based restriction for entering the elevator call after sending the request message or after receiving the acknowledgement message. In other words, if the user device moves too far from the respective elevator after sending the request or receiving the acknowledge message and/or a predefined maximum time period is exceeded after sending the request or after receiving the acknowledgement message, the application may disable entering the elevator call even if an acknowledgement message was previously received. Change of location can easily be detected in the user device by storing, by the application, the location of the user device at the time of sending the request and/or location of the user device at the time of receiving the acknowledgement, and obtaining the location again upon using the application for entering the respective elevator call. Likewise, a time stamp can be stored by the application at the time of sending the request and/or at the time of receiving the acknowledgement, and the amount of time passed since that stored timestamp may be calculated upon using the application for entering the respective elevator call.

Alternatively, the elevator call API may further be enhanced by including possibility to send user device's location to the upon entering a call for elevator service over the API, in which case the digital service platform may verify, that the location of the user fulfills a proximity criterion with the respective elevator. This proximity criterion may be the same that was used during validation of the request, or a different proximity criterion may be defined for entering the elevator call. In a further alternative or auxiliary functionality, the digital service platform may store a time stamp associated with the user identity or with the temporary user token in the temporary user database, wherein the time stamp may indicate the time of receiving the request or sending the acknowledgement message. Upon receiving an elevator call over the API, the digital service platform may compare the time of receiving the elevator call and compare this to the stored time stamps. Only if the time period between these is less than a maximum pre-defined period of time, the elevator call is accepted. It is apparent to a person skilled in the art that as technology advanced, the basic idea of the invention can be implemented in various ways. The invention and its embodiments are therefore not restricted to the above examples, but they may vary within the scope of the claims.

1. A method for enabling temporary interaction between a user device of a passenger and an elevator or an elevator group provided for public use in a public space, wherein the method comprises the steps of:
maintaining a database comprising information on at least one elevator or elevator group available for public use, said information comprising at least a unique identifier and a geographical location of each of said elevators or elevator groups available for public use;
receiving, from a user device, a request message comprising validation information, wherein the validation information comprises at least a unique identification of an elevator or elevator group;
obtaining a location of the user device;
validating said request message, wherein said validation comprises at least verifying that the unique identification of the elevator or elevator group in said validation information is among said at least one elevator or elevator group available for public use and that the location of the user device and the geographical location of the elevator or elevator group identified by the unique identification fulfill a predefined proximity criterion; and
if the request message is deemed valid, sending an acknowledgement message to the user device, wherein said acknowledgment message indicates a grant of a temporary access to an elevator application running on the user device for communicating with the elevator or elevator group identified in the request message via an elevator call application programming interface for entering at least one call for elevator service.

2. The method according to claim 1, wherein said predefined proximity criterion comprises at least one of:
a maximum predefined proximity radius between the location of the user device and the geographical location of the respective elevator or elevator group; and
a maximum estimated arrival time of the user at the respective elevator or elevator group by walking.

3. The method according to claim 1, wherein the method further comprises the steps of:
receiving a query from the user device, wherein the query comprises a location of the user device; and
in response to the query, providing information for the user device on at least one elevator or elevator group available for public use that fulfills the predefined proximity criterion.

4. The method according to claim 1, wherein the location of the user device is received in the request message.

5. The method according to claim 1, wherein the request message further comprises a unique user identity of a registered user, and in response to deeming that the request message is valid, the unique user identity of the registered user is stored in a temporary user database associated with the elevator or elevator group identified in the validation information, or
wherein the request message comprises a unique user identity, and in response to deeming that the request message is valid, a temporary user token is generated and stored in the temporary user database associated with the elevator or elevator group identified in the validation information, and the acknowledgement message comprises the temporary user token, or
wherein the request message does not comprise a unique user identity of a registered user, and a temporary user token is generated and stored in the temporary user database associated with the elevator or elevator group identified in the validation information, and the acknowledgement message comprises the temporary user token.

6. The method according to claim 5, wherein a subsequently received elevator call request concerning the elevator or elevator group is accepted, if the unique user identity of the registered user or the respective temporary user token included in the elevator call request is found in the respective temporary user database associated with the respective elevator or elevator group.

7. The method according to claim 6, wherein the unique user identity or the temporary user token is respectively removed from the temporary user database associated once the requested elevator call has been served and/or upon expiry of a predefined time period.

8. The method according to claim 1, wherein the validation information further comprises information on a current floor, and wherein the grant of a temporary access grants access for entering a call for elevator service between the current floor and a destination floor.

9. A method performed by an elevator call application running on a user device for enabling temporary interaction with an elevator or an elevator group provided for public use in a public space, wherein the method comprises the steps of:
interacting with a touchless token, wherein said interaction comprises obtaining validation information, wherein said validation information is publicly accessible at a location served by an elevator or an elevator group among at least one elevator and/or elevator group that is available for public use, and wherein said validation information comprises a unique identification of the respective elevator or elevator group;
generating, by the user device, a request message comprising said validation information, and sending said request message;
in response to said request message, receiving an acknowledgement message, wherein said acknowledgment message indicates grant of a temporary access to the elevator call application for communicating with the elevator or elevator group identified in the request message via an application program interface for entering a call for elevator service, wherein said acknowledgement message is received if the unique identification of the elevator or elevator group in said validation information is among at least one elevator or elevator group available for public use and that a location of the user device and a geographical location of the elevator or elevator group identified by the unique identification fulfill a predefined proximity criterion.

10. The method according to claim 9, wherein said predefined proximity criterion comprises at least one of:
a predefined maximum proximity radius between the location of the user device and the geographical location of the respective elevator or elevator group, and
a maximum estimated arrival time of the user at the respective elevator or elevator group by walking.

11. The method according to claim 9, wherein the method further comprises the steps of:
sending, by the user device, a query comprising the location of the user device; and
in response to the query, receiving information on at least one elevator or elevator group available for public use that fulfills the predefined proximity criterion.

12. The method according to claim 9, wherein said request message further comprises the location of the user device.

13. The method according to claim 9, wherein the request message further comprises a unique user identity of a registered user, or
wherein the request message further comprises a unique user identity, and the acknowledgement message comprises the temporary user token, or
wherein the request message does not comprise a unique user identity of a registered user, and the acknowledgement message comprises the temporary user token.

14. The method according to claim 13, further comprising the step of placing the elevator call for the respective elevator or elevator group, wherein the elevator call comprises the unique user identity of the registered user, or the elevator call request comprises the temporary user token.

15. The method according to claim 9, wherein the validation information further comprises information on a current floor, and wherein the grant of a temporary access grants access for entering a call for elevator service between the current floor and a destination floor.

16. A computer program product for enabling temporary interaction between a user device of a passenger and an elevator or an elevator group provided for public use in a public space, wherein the computer program product is embodied on a non-transitory computer readable medium and comprises computer executable code that, when executed by a computing device or a computing system, performs the steps according to claim 1.

17. A computer program product for enabling temporary interaction with an elevator or an elevator group provided for public use in a public space, wherein the computer program product is embodied on a non-transitory computer readable medium and comprises computer executable code that, when executed by a user computing device, performs the steps according to claim 9.

18. A system for enabling temporary interaction between a user device of a passenger and an elevator or an elevator group provided for public use in a public space, the system comprising:
a database comprising stored information on at least one elevator or elevator group available for public use, the database comprising a unique identifier and a geographical location of each of said elevators or elevator groups available for public use; and
at least one computer or computer system configured:
to receive, from a user device, a request message comprising validation information, wherein the validation information comprises at least a unique identification of an elevator or elevator group among the at least one elevator or elevator group;
to obtain a location of the user device;
to process the request message for validating, whether a request carried by the request message is valid, wherein the request is deemed valid, if the unique identification of the elevator or elevator group in said validation information is among said at least one elevator or elevator group that is available for public use, and that the location of the user device and the geographical location of the elevator or elevator group identified by the unique identification fulfill a predefined proximity criterion; and
upon determining that the request is valid, to send an acknowledgement message to the user device, wherein said acknowledgment message indicates grant of a temporary access to an elevator application running on the user device for communicating with the elevator or elevator group identified in the request message via an application programming interface for entering at least one call for elevator service.

19. The system according to claim 18, wherein said predefined proximity criterion comprises at least one of:
a predefined maximum proximity radius between the location of the user device and the geographical location of the respective elevator or elevator group; and
a maximum estimated arrival time of the user at the respective elevator or elevator group by walking.

20. The system according to claim 18, wherein the at least one computer or computer system is further configured:
to receive a query from the user device, wherein the query comprises the location of the user device; and
in response to the query, to provide information for the user device on at least one elevator or elevator group available for public use that fulfills the predefined proximity criterion.

21. The system according to claim 18, wherein the request message further comprises location of the user device.

22. The system according to claim 18, wherein the request message further comprises a unique user identity of a registered user, and in response to deeming that the request message is valid, at least one computer or computer system is configured to store the unique user identity of the registered user in a temporary user database associated with the elevator or elevator group identified in the validation information, or
wherein the request message further comprises a unique user identity, and in response to deeming that the request message is valid, at least one computer or computer system is configured generate a temporary user token and to store the temporary user token in the temporary user database associated with the elevator or elevator group identified in the validation information, or
wherein the request message does not comprise a unique user identity of a registered user, the at least one computer or computer system is configured to generate a temporary user token and to store the temporary user token in the temporary user database associated with the elevator or elevator group identified in the validation information, and to include the temporary user token in the acknowledgement message.

23. The system according to any claim 22, wherein the at least one computer or computer system is configured to accept a subsequently received elevator call request for the elevator or elevator group, if the unique user identity of the registered user or the respective temporary user token included in the elevator call request is found in the respective temporary user database associated with the respective elevator or elevator group.

24. The system according to claim 23, wherein the at least one computer or computer system is configured to remove the unique user identity or the temporary user token from the temporary user database associated once the requested elevator call has been served and/or upon expiry of a predefined time period.

25. The system according to claim 18, wherein the validation information further comprises information on a current floor, and wherein the grant of a temporary access grants access for entering a call for elevator service between the current floor and a destination floor.

26. A touchless token for use in the method according to claim 9, wherein said touchless token is a Quick Response (QR) Code, and Near Field Communication (NFC) tag, a Bluetooth Low Energy (BLE) beacon, and ultrasonic data-over-sound technology token or other known means of close-range wireless communication.
